(19) United States
(12) Patent Application Publication
(10) Pub. No.: US 2012/0284807 A1
(43) Pub. Date: Nov. 8, 2012

(54) Method of Producing and Distributing Copyrighted Content

(76) Inventor: Ronald W. Cowan, II, (US)

(21) Appl. No.: 13/460,758

(22) Filed: Apr. 30, 2012

Related U.S. Application Data
(63) Continuation of application No. 13/081,461, filed on Apr. 6, 2011.

(51) Int. Cl. G06F 21/00

(52) U.S. Cl. 726/30; 726/26

(57) ABSTRACT

The present disclosure teaches methods for producing and distributing content through a network in a way that is practicable and economical for both the owners of the content and the delivery service providers. The present disclosure teaches methods of using content to drive multiple revenue streams from a website that distributes such content.

### PRIORITY

The present application is a continuation of U.S. patent application Ser. No. 13/081,461, filed Apr. 6, 2011, entitled “A Method of Producing and Distributing Copyrighted Content,” which is incorporated herein by reference.

### BACKGROUND

Copyrighted content has generally reached the consumer through a tightly controlled distribution system. In the case of movies, content is first distributed though theatres that show the movies privately to ticket purchasers, then the content is placed on a mass produced storage medium such as DVD and sold or rented to consumers, and finally the content is broadcast through either commercial or subscription television.

This distribution system tends to fracture the established audience for a given piece of content and reduce cross-promotional opportunities by removing the social aspect of the experience.

Television shows are distributed first through broadcast commercial or subscription television, then through mass produced, commercial free retail storage such as DVD. Again, this distribution methodology tends to fracture the audience by removing the communal nature of the content, and thereby reduce cross-promotional opportunities.

Broadcast distribution can serve to rebuild an audience to some degree, but broadcast delivery has been limited to a broad spectrum of content produced recently, or a narrow spectrum of the most popular content produced some time ago. This is a result of the time intensive nature of the content; broadcasters have a limited amount of time to fill and simply cannot afford to broadcast several hours of older, less popular content. But that content does have a market value which is not currently being realized.

The current distribution system is also highly prone to piracy. Because the current distribution system tends to remove the communal element from the content experience, pirated content has become an acceptable alternative to many consumers, and the quality of broadcast content is adequate for the purposes of piracy. Therefore, once content has reached the broadcast distribution or retail media distribution phase, the content can be pirated and distributed by a digital computer network to provide the consumer with essentially the same experience the consumer would get by adhering to legitimate distribution methods.

Content owners attempting to take advantage of distribution by digital computer network have found themselves distributing their content, essentially free or at a loss, on an ad-hoc basis. This ad-hoc or “unicast” delivery structure directly results in audience fracturing. By breaking up audiences at every phase of distribution, the digital computer network consumer has no inclination to wait even a short amount of time for a larger audience which would allow economies of scale to develop.

Content delivered via digital computer network has been uneconomical because content owners and content-delivery service providers charge fixed rates for their services which exceed the revenue generated from the distribution of the content. At the same time, content owners have little success using their libraries of content to capitalize on the internet, television or radio marketplaces.

The content owners have also essentially put themselves in competition with content pirates. No party has effectively utilized economies of scale and methods of cross-promotion to reconstitute audiences for content and capitalize on additional revenue streams.

What is needed is a method of producing and efficiently delivering content to consumers in a form which enhances the communal experience, provides cross-promotional opportunities, and deters piracy.

### SUMMARY

The present invention is directed toward a method that satisfies the need to produce and deliver content to consumers in a form which enhances the communal experience, provides cross-promotional opportunities, deters piracy, and provides economies of scale.

One embodiment of the present invention teaches a method of distributing content via a digital computer network where the content would be distributed at randomly scheduled times; in which consumers would select a desired distribution time in advance, even if only a few minutes in advance; at the scheduled distribution time, a system of cloned streams would be created to distribute the content to each requesting consumer. The content delivered by each cloned stream would be identical; there may be an independent and targeted virtual data channel that includes cross-promotional material specifically related to the content; it may include facilities to allow the consumers to communicate with each other.

This method essentially merges enhanced digital distribution with the television model of broadcast distribution. Digital distribution will become more efficient and economical by creating a situation where the digital network load may be predicted with relative accuracy in advance, and by creating new revenue streams.

Content delivery over a digital computer network is inherently more efficient by this method. This method may also serve to reduce piracy of digital content, in part by promoting the communal nature of the content rather than the content itself because the communal aspect is necessarily unavailable to pirated content. For relatively recent content, this method may be integrated into the distribution chain earlier than digital computer network distribution has been previously, thereby enhancing cross-promotional opportunities at an early stage, and further forestalling piracy of digitally distributed content.

The method for delivering content across a network comprises the steps of forming a cooperative of content owners and producers (3), where each content owner or producer (1) grants the cooperative the right to license content (8) to a third-party broadcast distributor and website operator (5); forming a cooperative of content-delivery service providers (4), where each content-delivery service provider (2) grants the cooperative the right to negotiate terms for content delivery services (45); licensing the content from the cooperative of content owners and producers for distribution by the third-party broadcast distributor and website operator in exchange for a interest in the third-party broadcast distributor and website operator (44); and entering into an agreement between the third-party broadcast distributor and website operator and the cooperative of content-delivery service providers whereby the content-delivery service providers deliver the licensed content in exchange for an interest in the third-party broadcast distributor and website operator (9).

Content delivered by this method is delivered more economically than content delivered by other methods because the method creates an incentive on the part of content-delivery service providers to deliver the content as efficiently as possible. At the same time, both the content owners and producers, and the content-delivery service providers would benefit from each marginal distribution, which is not the case in the prior art.

These and other features, aspects and advantages of the present invention will become better understood with regards to the following description, appended claims, and accompanying drawings.

### LIST OF FIGURES

FIG. 1 shows an organizational chart detailing a business organization for producing and distributing copyrighted content economically.

FIG. 2 shows a flowchart for a process for preparing content for distribution.

FIG. 3 shows a flowchart for a process for distributing content over a digital network.

FIG. 4 shows a flowchart for a process for producing a content specific information element and combining said content specific information element with the specified content.

FIG. 5 shows a diagram detailing several types of content specific promotional materials.

FIG. 6 shows a diagram detailing how consumers are assigned to an age-specific social network.

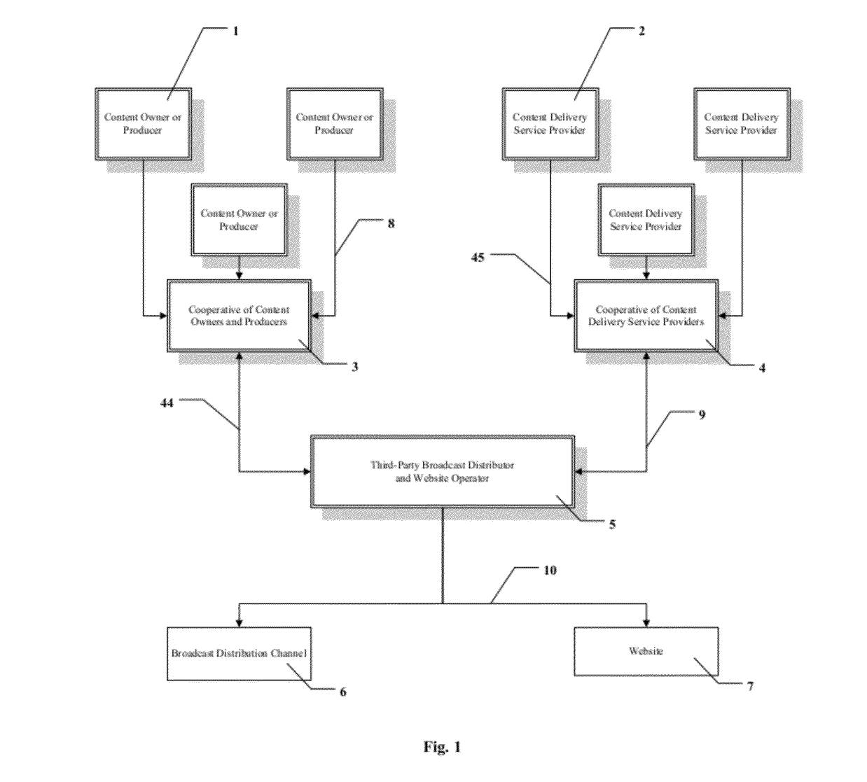

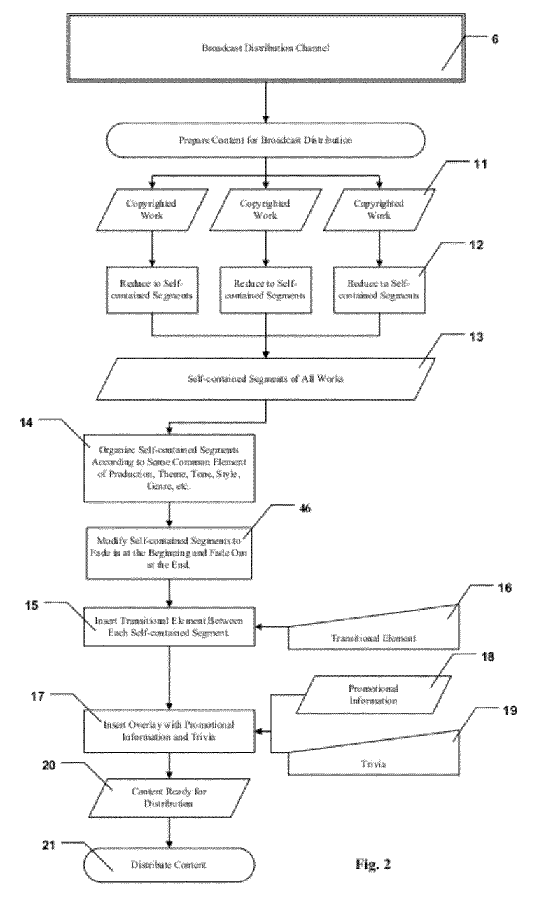

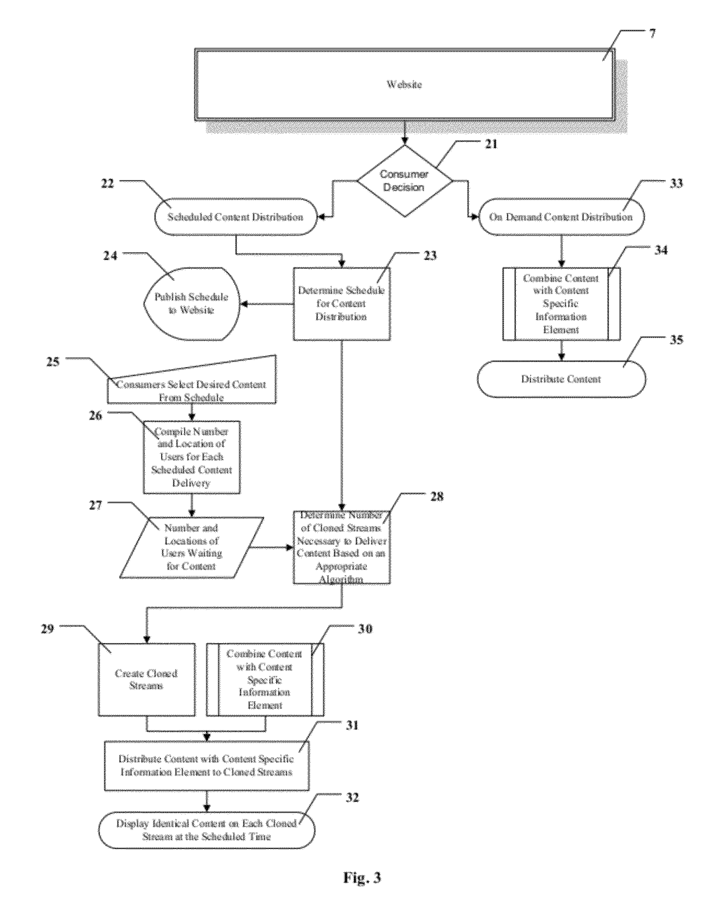

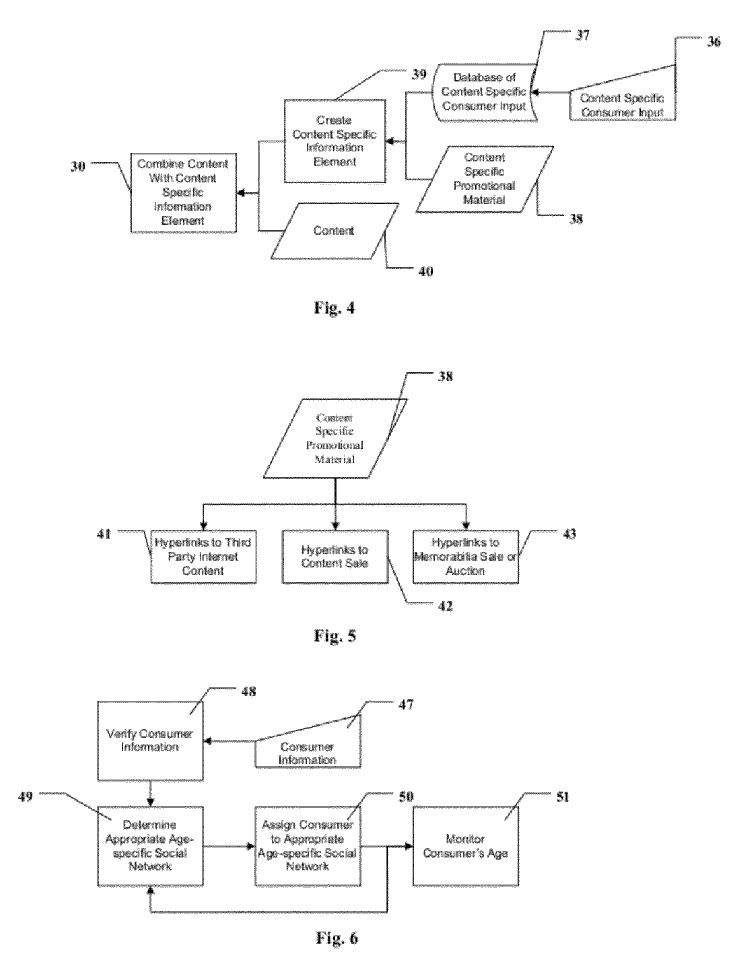

### DESCRIPTION OF INVENTION

In the following description, any references to a “user” or “users” is intended to refer to the service and content providers, and business operators who implement the present invention.

Any references to “consumer” or “consumers” is intended to refer to members of the general public who benefit from the invention as implemented by its users.

Any reference to “cooperative” or “cooperatives” is intended to refer to an organization wherein independent entities agree to voluntarily participate in an endeavor of common interest, and in which each independent entity has some voice in the management of the organization. A cooperative may have a formalized structure such as a partnership or corporation, or it may be a contractual relationship between the members.

The present invention teaches a method for producing content for distribution, said method comprising the steps of reducing copyrighted works into self contained segments (12) to produce a library of self-contained segments (13); selecting and organizing self-contained segments according to some common element of production, theme, tone, style, genre, or other criteria (14); and assembling said segments together. The method may further comprise the step of modifying said segments to fade from black at the beginning and fade to black at the end (46). Each segment may feature a unique or descriptive name in text; that name may appear during the scene or during an adjacent fade. Content produced by this method is primarily intended for delivery by broadcast, satellite or cable television, but not limited to such; it consumes less time than distributing the larger works in their entirety, thereby giving the content owner a viable option for distributing a portion of a larger work in a form that will evocate a memory of the larger work in the consumer and thereby produce an impulse to view or purchase the larger work.

The present invention further teaches inserting an overlay. When the content is to be distributed through a visual medium, the present invention teaches inserting a graphic overlay (17). Said graphic overlay may comprise consumer targeted promotional and advertising materials (18) and content specific trivia (19) or general information related to said content. The graphic overlay provides a means of delivering information relevant to the consumer at a time and place, and by a means likely to have the greatest impact. The graphic overlay is not intended to cover any part of the content. The content and the overlay would be formatted to allow the content and graphic overlay to be viewed unobstructed. Content may be reformatted to maximize unused space either above or below the content, and thereby allow maximum space for a graphic overlay without obstructing the content.

When the content is to be distributed through an auditory medium, the present invention teaches inserting an audio overlay. Said auditory overlay may comprise descriptive information about said content, or script directions from the original script.

In any medium, and any distribution method, the overlay may be in the form of one or more widgets. At least one widget might be a trivia widget pertaining to the content, and consumer commentary pertaining to the content. A widget might also be an “e-commerce” widget that would direct consumers to a vendor selling related products. Still another widget may be a “polling” widget to display the results of consumer polling. A widget may also be a means for alerting the consumer when content is scheduled to be distributed.

One embodiment of the present invention teaches selecting and organizing the self-contained segments according to an entirely new production outline. Thereby, segments from multiple works may be assembled to form one new artistic work without significant new content. This embodiment is novel in that an entirely new artistic work has never been produced from segments of multiple existing works.

The aforementioned larger works are generally subject to copyright protection. In order to make the distribution of copyrighted content practicable and economical, the present invention teaches a method of distributing copyrighted content across a network comprising the steps of forming a cooperative of content owners and producers (3), where each content owner or producer (1) grants the cooperative the right to license content (8) to a third-party broadcast distributor and website operator (5); forming a cooperative of content-delivery service providers (4), where each content-delivery service provider (2) grants the cooperative the right to negotiate terms for content delivery service (45); licensing the content from the cooperative of content owners and producers for distribution by the third-party broadcast distributor and website operator in exchange for an interest in the third-party broadcast distributor and website operator (44); and entering into an agreement between the third-party broadcast distributor and website operator and the cooperative of content-delivery service providers whereby the content-delivery service providers deliver the licensed content; and some service providers may deliver the licensed content in exchange for an interest in the third-party broadcast distributor and website operator (9). This method of distribution reduces the burden on content owners to distribute their content by giving the content-delivery service providers a financial interest in delivering the content efficiently.

The content produced by the forgoing methods and distributed by the foregoing methods may be distributed by any kind of network capable of distributing such content. The inventors specifically envision distribution by broadcast television, cable television, satellite television, broadcast radio, satellite radio, or digital computer network of any architecture including client-server, peer-to-peer, or active network. Digital computer networks include network enabled consumer devices such as gaming devices, digital media players and televisions. The inventor also specifically envisions website and social network delivery through television, cable and radio networks in addition to more traditional digital computer networks.

Distribution by digital computer networks can create separate risks of unauthorized copying. The inventor envisions a method of distribution by computers or digitally networked devices that significantly reduces that threat by warning the consumer that there are systems in place to monitor for copying and the associated consequences, monitoring those functions indicative of unauthorized copying, and imposing significant and immediate consequences for attempted unauthorized copying by a consumer. The method for deterring unauthorized copying of works distributed by digital network comprises the steps of obtaining contact information from a consumer; recording said contact information in a database; recording said consumer's IP address in said database; notifying said consumer of the consequences of unauthorized copying; and monitoring said consumer's computer for activity indicative of unauthorized copying. IP addresses must be verified as one that corresponds with an existing account; otherwise an anti-piracy response may be initiated. The method may further comprise the step of recording said consumer's MAC address.

In order to record device information, warn the consumers and facilitate this purpose, the method may further comprise the step of installing a program on said consumer's computer or device to monitor said consumer's computer for activity indicative of unauthorized copying. In that case, the method may also comprise the steps of monitoring the status of said program; and terminating said consumer's access to the works if said program is terminated.

If the method above detects activity indicative of unauthorized copying, the method may further comprise the steps of immediately terminating said consumer's access to the works; and transmitting said consumer's contact information and a report of the consumer's activity which is indicative of unauthorized copying to the copyright holder of the works. Alternatively, rather than immediately banning the consumer, the consumer's access to the work may be terminated, but the consumer would be warned that a second attempt would lead to a permanent ban; thereby applying the deterrence methodology to the offending consumer as well as all other consumers.

The communal aspects of content consumption are fostered through age specific, media oriented social networks, and through communal viewing of the content.

### PREFERRED EMBODIMENT

The inventor's preferred embodiment of the present invention is a method of delivering copyrighted movies, television shows and audio events comprising the steps of forming a cooperative of content owners and producers (3), including production companies, unions, guilds, writers, directors, actors, studios, musicians and copyright owners where each owner or producer (1) grants the cooperative the right to license content (8) to a third-party broadcast distributor and website operator (5); forming a cooperative of content-delivery service providers (4), primarily internet service providers but also including broadcast, satellite and cable service providers, where each content-delivery service provider (2) grants the cooperative the right to negotiate terms for content delivery services (45); forming a third-party broadcast distributor and website operator (5) to hold the licenses granted by the cooperative of content owners and producers (3); granting a non-exclusive, revocable license from the cooperative of content owners and producers to the third-party broadcast distributor and website operator to distribute the content, either in whole or in part, and perform any others operations on the copyrighted works as may be necessary in exchange for an equity interest in the third-party broadcast distributor and website operator (44); and entering into an agreement between the third-party broadcast distributor and website operator and the cooperative of content-delivery service providers whereby the content-delivery service providers deliver the licensed content in exchange for an equity interest in the third-party broadcast distributor and website operator (9). Each cooperative, as a partial owner of the third-party broadcast distributor and website operator, would be entitled to a share of the profits generated by the content. Each cooperative would distribute those profits according to an agreement by the members. The inventor specifically envisions a revenue sharing arrangement whereby the owners of a particular piece of content would be entitled to fifty percent (50%) of the revenue from any transactions for said content, the service provider who delivered said content would be entitled to twenty-two and one half percent (22.5%) of the revenue from any transaction the service provider facilitated, the third-party broadcast distributor and website operator would be entitled to twenty-two and one half percent (22.5%) of the revenue from any transaction it facilitated, and the content producers would be entitled to five percent (5%) of the revenue from each transaction.

Each particular piece of content may be assigned a value level within a uniform pricing environment. The value level of a particular piece of content may be based on various factors such as: is the content widely considered a “classic?” how long ago was the content released? are there any extraneous factors contributing to the popularity of the content? etc. The value level of a particular piece of content may be used to set the price, or the initial price for that piece of content under various delivery schemes as outlined herein. The value level may also be used to determine the fee paid to the cooperative of content producers.

The inventor also foresees the cooperative of content owners and producers, and the cooperative of content-delivery service providers would be administered through a “cloud” environment. The cooperative of content-delivery service providers would supply resources as necessary to accomplish such administration. The inventor specifically envisions one or more content-delivery service providers providing resources to establish a cloud environment where each cooperative can conduct business and digitize, upload, manage and restore copyrighted content; and to communicate generally using XMPP. The inventor specifically envisions a regional tier 1 cloud. The regional tier 1 cloud ensures unfettered access to copyrighted content through any internet service provider. The regional tier 1 cloud also allows the cooperative of content owners and producers to limit access to content by region.

The embodiments of the invention envisioned by the inventor require content to be digitized. Therefore, the inventor envisions an embodiment of the invention whereby the cloud environment also functions as an archive of digitized content. The cloud environment would provide archival and restoration services for cooperative members, or for non-cooperative members for a fee. Content will be transferred via IP encapsulation. All content will be encoded with meta-data. The inventor envisions using data center Ethernet in network studios and network operation centers for the lossless data transfer of content.

The third-party broadcast distributor and website operator would operate one or more television channels (6) and one or more websites (7). Each television channel and website may be a wholly owned subsidiary of the third-party broadcast distributor and website operator. At least one television channel would broadcast content comprising complete, uninterrupted scenes from movies or television shows while another channel would provide full length features chosen by the general audience through interaction with website. The scenes would fade from black and fade to black with transitional elements between each scene. The broadcast would include a graphic overlay and individual scenes or blocks of scenes which may be sponsored by an advertiser.

The transitional elements (16) would comprise textual content made up of material appropriate to introduce subsequent content, contrast subsequent content with prior content, or set or maintain a certain mood. Content may comprise programmed blocks of content with similar themes or from similar genres. The inventor envisions a significant amount of text would be supplied by users.

The graphic overlay would comprise trivia (19), polls, user comments and promotional information (18) related to the scene. Some trivia would likely be supplied by users familiar with the scene but may also include “nostalgic” consumer comments (19), famous lines, lyrics, poll information or poll questions. The promotional information (18) would further comprise information directing the viewer to the website (7) for purchase or related information, or discount codes to receive content provided by hyperlinks. The trivia and promotional information featured in the graphic overlay would be particularly relevant to the content being shown at that time; trivia could include other works by the actor or director featured in the present scene, box office information for the opening weekend of the movie that featured the scene, or any other information potentially interesting to the relevant consumer base. Promotional information could include notices about e-commerce availability of merchandise and memorabilia related to the movie that featured the present scene, or an offer to watch the entire movie on the website or television channel, or listen to the movie or soundtrack on a radio channel (7).

The third-party broadcast distributor and website operator may also operate independent radio channels. A radio channel would broadcast content comprising entire movies or television shows, or serialized segments of entire movies or televisions shows, with an auditory overlay that includes script directions, descriptive information or other commentary. The radio channel may also rebroadcast live television channels, potentially with similar audio overlays.

The inventor also envisions alternate audio tracks comprising comments contributed by consumers.

The website (7) would include a family of social networks. Each social network would be age specific. Consumers of each social network would be required to supply limited types of new user information, and individualized contact information known in the art, such as a telephone number. The inventor specifically envisions collecting information other than the consumer's Social Security Number, name and physical address. Information gathered from the user would be validated to the extent possible; for example, the user would be required to supply a telephone number which would then be called through a privacy protected automated process to confirm the account's validity. All user information that is collected would be used to strictly enforce the rules of each social network.

Each social network is based on the communal nature of entertainment media. Specifically, each social network is intended to provide a forum for consumers of similar demographics, to view and discuss content. By making each social network age specific and strictly enforcing the age specific nature of each social network through the use of the consumer information gathered and validated during the initial registration, the inventor has disclosed a means for combating the predatory aspects of some social networks. The inventor has also disclosed a means for making broad social networks, which tend to skew toward a certain demographic, useful and meaningful to a much broader cross section of consumers.

Each social network may be independently governed and operated democratically, with each user having the ability to submit potential policies and each user having the ability to vote on the policies that will govern the network. Each network would essentially be a fraternity. The consumers of each social network may elect a board to represent their interests. There may also be an elected president of the social network. Each social network may further comprise a cloud environment which may be utilized by consumers to archive purchased content.

Each social network can be formed as a non-profit entity that may be owned by the ownership or membership collectively.

The website, and potentially each social network, would have a personalized chat feature for every available television or radio network. Consumers would thereby be able to connect with other consumers watching or listening to the same channel in a communal environment. For chat rooms appearing in an age specific social network, chat rooms for certain channels may be restricted from that network based on age appropriateness. All chat rooms will provide a customizable chat environment.

Specific pieces of content may have “profiles,” whereby consumers can learn about the content and enter a customizable chat room devoted to the content. Chat rooms may be created on an ad-hoc basis, and all chat rooms would utilize XMPP signaling. All signaling may utilize XMPP.

The website, and potentially each social network, may also feature a search engine specifically for media air times or schedules. The search engine would allow the consumer to search for media by show, character, performer, or other criteria specific to media content, and display a list of relevant matches available for consumption on the website or through broadcast, or an indication that the content is only available on DVD or in movie theatres with release dates or schedule times. Pirated and unauthorized content results may be filtered to protect and promote legitimate copyrighted content.

Each social network would feature options for consumers to access audio visual content, possibly with the addition of one intermission, for a micro-fee, typically less than a dollar, or for free with additional commercial advertisements. A consumer would execute micro-fee transactions by establishing an online account, then borrowing or purchasing content through that account. The account may or may not be associated with a debit or credit card, and the account may or may not have a surplus balance at any given moment. Each account will track historic payment data and other relevant criteria to determine an internal “creditworthiness” rating which may be used to determine how many transactions a consumer can make without a surplus balance in that consumer's account.

If the online account does not have a surplus balance, transaction fees are recorded until the account balance reaches some predefined minimum amount, at which time the consumer's debit or credit card will be charged, or the consumer will be directed to make an appropriate deposit into the account. By accumulating transaction fees until a minimum amount is reached, each transaction will be subject to lower relative fees, and all transaction fees will be reduced and profit margins are improved.

The content may be delivered by request (33), at ad-hoc scheduled times (22) via cloned stream client-server distribution with streams cloned based on some algorithm for load distribution. The content may also be delivered as serialized segments. Serialized segments of content may be delivered to mobile devices. The inventor specifically envisions using an IP level client-server approach to distribute cloned streams; however, other architectures such as peer-to-peer or hybrid IP-P2P which can be utilized instead depending on what the ideal mechanism for delivery is and depending on network resources that are consistently available. In the context of this application, cloned stream should be understood to include non-contiguous data packets in addition to data streams. Whether content is privately delivered on demand or publically delivered at scheduled times, the content would be combined with a content specific information element (30) via out of band XMPP signaling. The content specific information element would be produced by allowing consumers to contribute input about the content (36); creating a database of content specific consumer input (37); creating a content specific information element (39) by combining data from the database of content specific consumer input (37) with content specific promotional material (38); and combining the content specific information element with the content. Content submitted by consumers would be reviewed and edited by the user, and tagged to appear at a relevant time relative to the content in any future distribution in which the content appears. What constitutes a relevant time may be a function of the relative time at which the consumer's comment was submitted and the user's judgment. Consumer comments are parsed and formatted, then stored in an electronic database. Comments may be edited by the user for profanity. Consumer comments may be used for a variety of applications.

Consumers may elect to view a number of information elements at one time, and to arrange them according to the consumer's preferences. The inventor specifically envisions a non-uniform environment, customized by the consumer to display those information elements and widgets desirable to the consumer. The inventor specifically envisions customizable chat environments, and not a uniform chat environment as is known in the prior art.

Where the content is to be delivered on demand for private viewing for a premium fee or by subscription, the inventor envisions additionally using means and methods known in the art to deliver the content with slight variations. The content would be combined with a content specific information element (30) which content specific information element would be viewable or not at the option of the consumer.

Where the content is to be delivered at a scheduled time, the method for delivering the content would comprise the steps of determining a schedule for content distribution (23); displaying said schedule for content distribution (24); determining the number of consumers intending to receive the content at a scheduled time for content distribution (27); determining the number of cloned streams necessary to deliver the content at the scheduled time based on some appropriate algorithm (28); creating cloned streams (29); creating a content specific information element (39) by the steps of allowing consumers to contribute input about the content (36), creating a database of content specific consumer input (37), and combining data from the database of content specific consumer input (37) with content specific promotional material (38); combining said content specific information element with the specified content (40); and distributing said combined content and content specific information element to each cloned stream (31). Cloned streams may be distributed and cached in advance, but simultaneous audience playback will be restricted until the scheduled time. By this method the practitioner could estimate the number of consumers with great accuracy in advance of content actually being delivered, and more efficient network routes can be created. Therefore the total likely bandwidth required to deliver the content becomes more predictable and manageable and the expense of delivering the content is reduced. With a predictable and manageable bandwidth requirement, and efficient network routing, delivery to the consumers would be faster, more reliable and more economical.

Also, where the content is delivered at a scheduled time, the inventor envisions a virtual button on the website in close proximity to where the consumer will actually view the content. The virtual button would be a virtual button as commonly understood in the art, and would be disabled until one to five minutes before actual content delivery is scheduled to begin, at which point the virtual button is enabled and the consumer pushes the virtual button to indicate his or her readiness to receive the content. The virtual button serves two purposes; first, the virtual button is means of alerting the consumer that the transaction is about to be finalized and the content is about to begin. Second, the virtual button is a means for performing a test of the proposed stream distribution; the server would track the time at which the signal to enable the virtual button was sent, and the client would return the time at which the signal was received; the server would thereby be able to determine the amount of time necessary to send a signal to each consumer, and the ideal network route for maximum network efficiency. A similar calculation could be performed when the virtual button is pressed by the consumer. In this way, the server can determine the efficacy of intended cloned stream architecture based on the relative transit times to each consumer.

Furthermore, the inventor envisions a method of compiling consumer data based on discontinued streams during content delivery. Specifically, whenever a stream is discontinued by the consumer, the online account associated with that stream and the time the stream was discontinued would be logged by the server; the server would then cross reference the personality type associated with that online account to determine how desirable the content was to various personality types retrospectively. Such data may then impact future micro-fee transaction amounts, influence recommendations to personality types, and be used to fine-tune final load balancing calculations for immediate and future content delivery.

While consumers wait for content to be delivered at a scheduled time, they may have the option of receiving sponsored material. The inventor envisions that such sponsored material would specifically relate to the content in some way.

Where content is delivered at a scheduled time for a “micro-fee,” the micro-fee may be dynamically calculated. The consumer would agree to some maximum amount; that amount may then dynamically change based on the number of other consumers who elect to receive the content at the same scheduled time. The dynamic micro-fee methodology creates a financial incentive for each consumer to recruit others for the same content, in addition to the incentive of a more socialized experience, which allows for economies of scale.

The initial maximum micro-fee amount and discount increment amounts may be determined based on prior consumer interest and the plurality of personality type as described above, as well as estimations of total costs and overhead. The initial calculation also requires an estimation of a minimum audience size. Audience size may be estimated in a number of ways. One method of audience estimation includes having each device connected to the network send a pulse in response to a network request with a probability factor. Another method includes sampling the available audience, and using the audience sample to estimate likely viewership based on some algorithm. Any method of estimation involving signals to or from audience members would include some method of feedback control to avoid network overload from uncoordinated responses. The audience estimation method may also include a noise reduction and signal processing method to enhance the accuracy of the estimation; the inventor specifically envisions a Kalman filter or a Wiener filter under appropriate circumstances.

The current, dynamically determined micro-fee may be displayed and continuously updated; the initial maximum micro-fee may also be continuously displayed. Scheduled events may be canceled if a minimum audience size is not achieved. After presentation, audience size is recorded for all events and added cumulatively to audience estimations from all other delivery methods for determining the collective audience size and demographic composition statistics.

The inventor envisions a portion of the network where consumers may view scheduled content delivery times and see current, dynamically determined micro-fee prices for some or all of the currently scheduled content deliveries.

The inventor envisions the use of automated programs, commonly known as “bots,” to monitor chat environments, mine data, interact with consumers, perform audience estimation to all networked devices, enforce security measures, customer service, quality assurance and polling.

The inventor envisions a customizable chat room for each scheduled distribution where consumers can interact before the distribution. The customizable chat room may feature sponsored art pertaining to the content, including previews or sponsored content.

In a customizable chat environment, individuals may be given a visual representation of the degrees of separation between one consumer and another consumer currently using the chat room; for example, friends of the consumer may appear in red while friends of friends of the consumer would appear in blue or distinguished by another similar visual characteristic or reference. Such representations may be made to an arbitrary degree of separation.

All content, whether delivered on demand for a onetime fee or a recurring fee, as part of a subscription service, may be additionally supported by ad revenue, or any combination thereof. Consumers may suggest content for scheduled mass delivery.

For any means for distribution by digital computer network, the inventor envisions a method to deter attempted unauthorized copying. The method envisioned by the inventor comprises the steps of requiring registration by the consumer; during registration the consumer would be required to give unique contact information specific to the consumer such as a cellular telephone number. That information, along with machine specific identification information such as an IP address and MAC address, would be recorded in a database. The consumer would then be required to verify such information through means known in the art. After verification, the user may be required to install a program on the consumer's computer to monitor the computer for activity indicative of unauthorized copying. Such activity includes, but is not limited to, unauthorized use of the computers clipboard to copy individual frames of content. The inventor also envisions an operating system level process to monitor for such activity.

The consumer would be warned in advance that any attempt at unauthorized copying may result in immediate termination of the consumer's access to the works and the website; and that the consumer's unique contact information, as well as all evidence of the consumer's unauthorized copying, would be transmitted to the rightful copyright holder. This way, the consumer will know that his activity is being monitored, and that he has already provided sufficient unique information to facilitate his identification.

In the event the consumer engages in activity indicative of copying, the consumer's access to the stream would be immediately terminated, and the user would be warned that a second attempt would result in a permanent ban from all access to the website and copyrighted content. In the unlikely event the consumer engages in activity indicative of copying a second time, the consumer will be permanently banned from the website and the copyright holder of the content will be notified of the attempted copying and given some or all of the contact information for the consumer. The consumer is hindered from ever gaining access to the website again because the website would not allow a new registration with the same contact information or machine specific identification information.

When the appropriate circuitry is available, each stream would engage an authorized addressable device output. Authorized addressable device outputs are devices that are directly addressable from a network connection to restrict output to only specifically addressed outputs. When such circuitry is not available, analog copy protection, as known in the prior art, is combined at the source so that playback will be identical to the original analog content with added protection for devices with analog outputs. However, the use of addressable device output should not be considered a limitation.

Each cloned stream may also have facilities to allow communication, either text chat, voice chat or video chat, between the consumers connected to a specific server, or between all consumers viewing the content contemporaneously on every server. Such communication would probably, though not necessarily, be through the client connected to the server. The inventor envisions a facility to “soft mute” or dynamically adjust audio from one or more of the cloned streams to allow consumers to engage in audio chat while still listening to the content audio. The inventor also envisions “speech to text” functionality to allow consumer comments to be converted to text and to provide fewer distractions to the presentation of audio and video from a stream. The inventor specifically envisions the use of the Extensible Messaging and Presence Protocol (XMPP) for this application. The means and methods of such communication are known in the art. All administrative and signaling functions will be accomplished through XMPP out of band signaling. The use of XMPP prevents requests from being lost based on multiple requests over-exerting network resources. The inventor also envisions coordinating multiple widgets on each consumers display using XMPP. Content may be distributed simultaneously to users on one or more of the social networks that comprise the website. The inventors envision cross-consumer communication confined to each social network to enhance the security of each social network.

The content specific promotional material may include at least one hyperlink which directs the consumer to a sale or auction of memorabilia or merchandise related to the self-contained segment or the larger work (43); at least one hyperlink which directs the consumer to an area where the larger work, or other related media is available for purchase (42); or at least one hyperlink which directs the consumer to a third-party website (41). The consumer would have the option to queue selected hyperlinks and wait for the end of the content to view the linked material.

Each social network would also offer links to secondary content based on movies or television shows featured on the website, though not necessarily specific to the content the consumer was currently viewing. Secondary content would include links to stores or auctions featuring memorabilia, links to stores allowing the consumer to download digital copies of the movies, television shows, audio or video games or discussion forums about the movies, television shows, audio or video games.

Each social network, being primarily designed to facilitate media consumption, may also provide a market for consumers to trade media legally which exists in a physical format such as CD or DVD. The inventor does not envision online sharing of digital media between individual consumers and will not provide any facilities for unauthorized sharing of copyrighted materials.

The inventor envisions website revenue streams including fees to view each piece of content, either on demand privately for a premium price or publicly, at scheduled times at more affordable rates, revenue from media sales such as DVDs, revenue from memorabilia sales and auctions, revenue from third-party ad sales, and bulk subscriptions to view content. The fee to view an individual piece of content may be determined on a sliding scale based on the number of consumers that request to receive the content. Such sliding scale may also be based on factors such as the general popularity of the content as well.

XMPP bots may be used to confirm audience estimates. An advanced and accurate estimate of audience size is vital to efficient delivery, pricing, and discovery of unauthorized access, to deter piracy.

The inventor also envisions broadcast revenue streams including basic subscriptions with content from older releases and premium subscriptions from content that contains newer releases, affiliation fees, revenue from third-party ad sales, revenue from syndication, and ecommerce. Where revenue is generated through ad sales, ads would be inserted into an overlay and also delivered in a traditional non-text format as found in the prior art. Ads may be demographically or geographically specific, or specific to personality types, and not based on the projected content demographics as has been used traditionally.

In addition to the technical efficiencies achieved in producing and distributing content, the present invention offers cross-promotional opportunities that are unknown or completely unutilized presently.

Each social network would promote further content consumption by allowing consumers to recommend available content to each other, or by allowing consumers to see what other consumers have accessed or are currently accessing. Consumers would have the ability to rate each other on some basis that would give other consumers an indication of the quality of their recommendations or individual reliability.

In addition to recommendations, the inventor envisions tracking the viewing habits of consumers to recommend potential viewing options for consumers with similar viewing habits. Such tracking may give additional weight to consumers with a high rating on the quality of their recommendations, and it may give additional weight to personal reviews and ratings of content submitted by consumers.

Initial recommendations for a consumer may be made based partially on a survey completed in advance, or dispersed surveys of varying length; an online assessment of the consumer's locally stored content; or an analysis of the consumer's actions online such as reviews, instant messages, chat room posts, etc. The inventor envisions a continuing, transparent process to assign each consumer to appropriate personality types based on all potentially available data. The inventor envisions ongoing analysis of content consumption habits in various contexts such as different moods, different times of day or different social situations. Such data may be correlated with the type of media consumed. A consumer's assigned personality type may change over time, and new personality types may be created.

The inventor envisions surveys and recommendations entered using a one click 100 point scale that will allow the consumer to click on a graphic representation of a scale. Where the consumer clicked will then be recorded and converted to a numerical value on that scale. All data from whatever source may be assigned a weight based on the predictive accuracy of that data. All data will be compiled to a numeric string representing the consumer's personality type for content consumption. Different personality types may be determined for different types of media such as movies, television shows and music.

Categorization of content will generally be accomplished by allowing consumers to rate the content, then correlating the personality type of that consumer to the rating. Additional data relating personality types to personal ratings may be acquired from all available data sources as described above. By aggregating all of the personality types and personal ratings, the content may be assigned a content profile representing relevant information concerning the content, and reviews and personal ratings correlated to various personality types in the form of text, audio or video, or any combination thereof. As each personality type represents a broad range of content preference in a number of different situations, content recommendations based on personality type may change based on the situation. In all cases, content recommendations are intended to congregate large, like-minded audiences rather than match individuals to each other; therefore recommendations may change based on profiles of available audiences.

Consumers approaching the age limit of one age specific social network would be automatically transitioned to the next age specific social network with potentially some exceptions for consumers who would do not wish to transition to a senior's oriented social network. The consumer would continue to have access to all of the same content, but would not have access through the social network to consumers on a different age specific social network.

The inventor has hereby disclosed methods of producing and delivering new, cost-effective content to consumers in a form which enables the communal experience and provides cross-promotional opportunities while deterring piracy and providing economies of scale.

The inventor claims:

1. A method for deterring piracy of works distributed by digital computer network, such method comprising the steps of:
a) asking for contact information from a consumer over a digital computer network executing computer code configured to collect such information;
b) recording said contact information in a database running on a digital computer configured to run said database;
c) recording said consumer's IP address in said database;
d) notifying said consumer of at least one consequence of piracy over a digital network executing computer code configured to deliver such notification; and
e) monitoring said consumer's computer for activity indicative of piracy, wherein such monitoring is performed by computer code configured to perform such monitoring.

2. The method of claim 1: further comprising the steps of recording machine specific identification information in said database, wherein such recording is performed by computer code configured record machine specific identification information.

3. The method of claim 1: where the step of monitoring said consumer's computer for activity indicative of piracy is accomplished by an operating system level process.

4. The method of claim 1: further comprising the step of installing computer executable program code on said consumer's computer to monitor said consumer's computer for activity indicative of piracy.

5. The method of claim 4: further comprising the steps of:
a) monitoring the status of said computer executable program code; and
b) terminating said consumer's access to the works if said computer executable program code is terminated.

6. The method of claim 1: further comprising the steps of:
a) immediately terminating said consumer's access to the works; and
b) warning said consumer that a second attempt at copying will result in said consumer being permanently banned from access to any works distributed by said digital computer network.

7. The method of claim 1: further comprising the step of transmitting all of said consumer's available contact information and machine specific identification information from said database, and a report of the consumer's activity which is indicative of piracy, to a copyright holder of the works, via a digital computer network configured to transmit such information.
